(19) United States
(12) Patent Application Publication
(10) Pub. No.: US 2026/0152671 A1
(43) Pub. Date: Jun. 4, 2026

(54) PROTECTIVE SHEET AND PROTECTIVE SHEET WITH PRESSURE SENSITIVE ADHESIVE LAYER

(71) Applicant: LINTEC CORPORATION, Tokyo (JP)

(72) Inventors: Yuka FUJII, Tokyo (JP); Yoichi TAKAHASHI, Tokyo (JP); Daiki FUKUDA, Tokyo (JP)

(73) Assignee: LINTEC CORPORATION, Tokyo (JP)

(21) Appl. No.: 19/404,439

(22) Filed: Dec. 1, 2025

(30) Foreign Application Priority Data
Dec. 2, 2024 (JP) 2024-209664

(51) Int. Cl. C09J 7/29

(52) U.S. Cl. CPC C09J 7/29; C09J 2301/162; C09J 2301/302; C09J 2301/416; C09J 2475/006

(57) ABSTRACT

Protective sheet includes a base material and a coat layer. The protective sheet has a tensile elongation of 60% or more at which the base material does not break but the coat layer cracks when the protective sheet is stretched at a width of 15 mm, a measurement length of 50 mm, and a tensile speed of 200 mm/min in an environment of 23° C. and 50% RH. The protective sheet has an indentation stress of 1 N or more and 8.8 N or less when a surface of the protective sheet or a laminate including the protective sheet on the coat layer side is indented to a depth of 100 μm at a speed of 0.01 mm/sec over an area of 5 mmφ.

### TECHNICAL FIELD

The present invention relates to a protective sheet and a protective sheet with pressure sensitive adhesive layer that are able to be used to protect coating films and the like.

### BACKGROUND ART

Coating films are formed by painting on the surfaces of exterior members of automobile bodies to enhance design and rust resistance. The coating films on the surfaces of exterior components are often damaged by scratches during travel, scratches caused by sand and dust/flying stones, scratches caused by fingernails, scratches caused by luggage, etc. For this reason, a coating film protective film may be applied to the entire automobile body to protect the coating film, and for this purpose, it is desirable that the coating film protective film should be scratch-resistant.

Furthermore, coating film protective films have to be applied to automobile bodies, which have many curved surfaces. To this end, coating film protective films are required to have workability to follow highly curved sites.

Patent Document 1 discloses a coating film protective film having high followability to curved surfaces, while Patent Document 2 discloses a pressure sensitive adhesive film that maintains excellent scratch resistance even after stretching.

### PRIOR ART DOCUMENTS

### Patent Documents

Patent Document 1: JP5989291B
Patent Document 1: JP2020-125400A

### SUMMARY OF THE INVENTION

### Problems to be Solved by the Invention

However, until now, no protective sheet has been known that has both the above workability and scratch resistance. Meanwhile, scratch resistance can also be interpreted as the ability of the protective sheet surface to return to its original state, in other words, scratch recovery, even if the sheet is scratched, so that the scratch becomes invisible within a short period of time.

The present invention has been made in consideration of the above actual circumstances, and an object of the present invention is to provide a protective sheet and a protective sheet with pressure sensitive adhesive layer that are able to easily follow curved surfaces, have excellent workability, and also have excellent scratch recovery.

### Means for Solving the Problems

To achieve the above object, first, the present invention provides a protective sheet comprising a base material and a coat layer, the protective sheet having a tensile elongation of 60% or more at which the base material does not break but the coat layer cracks when the protective sheet is stretched at a width of 15 mm, a measurement length of 50 mm, and a tensile speed of 200 mm/min in an environment of 23° C. and 50% RH, the protective sheet having an indentation stress of 1 N or more and 8.8 N or less when a surface of the protective sheet or a laminate including the protective sheet on the coat layer side is indented to a depth of 100 μm at a speed of 0.01 mm/sec over an area of 5 mmφ (Invention 1).

The protective sheet according to the above invention (Invention 1) particularly has the above coat cracking elongation thereby to exhibit high flexibility and extensibility, and can easily follow curved surfaces and provide excellent workability. Moreover, particularly due to the above indentation stress, even if the coat layer is scratched, the scratch becomes less visible within a short period of time (e.g., 0.1 to 10 minutes), and the surface of the above protective sheet easily returns to its original state, resulting in excellent scratch recovery.

In the above invention (Invention 1), the ratio of an indentation amount (μm) when a load of 10 N is applied to the surface of the protective sheet on the coat layer side at a speed of 0.01 mm/min over an area of 5 mm diameter to the thickness (μm) of the protective sheet is preferably 72% or more and 99.9% or less (Invention 2).

In the above invention or inventions (Inventions 1 and 2), the coat layer preferably contains a silicone component (Invention 3).

In the above invention or inventions (Inventions 1 to 3), the coat layer preferably contains a fluorine-based polymer and a silicone component (Invention 4).

In the above invention or inventions (Inventions 3 and 4), the silicone component is preferably cured by active energy rays (Invention 5).

In the above invention or inventions (Inventions 1 to 5), the coat layer is preferably cured by active energy rays (Invention 6).

In the above invention or inventions (Inventions 1 to 6), the surface of the protective sheet on the coat layer side preferably has a water contact angle of 1000 or more (Invention 7).

In the above invention or inventions (Inventions 1 to 7), the surface of the protective sheet on the coat layer side preferably has an oleic acid contact angle of 520 or more (Invention 8).

In the above invention or inventions (Inventions 1 to 8), the base material is preferably composed of a material containing 10 mass % or more of polyurethane (Invention 9).

In the above invention or inventions (Inventions 1 to 9), the base material preferably has a thickness of 10 μm or more and 300 μm or less (Invention 10).

In the above invention or inventions (Inventions 1 to 10), the coat layer preferably has a thickness of 1 μm or more and 50 μm or less (Invention 11).

Second, the present invention provides a protective sheet with pressure sensitive adhesive layer, comprising: the protective sheet (Invention or inventions 1 to 11); and a pressure sensitive adhesive layer laminated on a surface of the protective sheet on the base material side (Invention 12).

### Advantageous Effect of the Invention

The protective sheet and protective sheet with pressure sensitive adhesive layer according to the present invention can easily follow curved surfaces and provide excellent workability, and are thus excellent in the scratch recovery.

### BRIEF DESCRIPTION OF THE DRAWINGS

FIG. 1 is a cross-sectional view of a protective sheet according to an embodiment of the present invention.

FIG. 2 is a cross-sectional view of a protective sheet with pressure sensitive adhesive layer according to an embodiment of the present invention.

### EMBODIMENTS FOR CARRYING OUT THE INVENTION

Hereinafter, one or more embodiments of the present invention will be described.

### <Protective Sheet>

Protective sheet according to an embodiment of the present invention includes a base material and a coat layer. The protective sheet preferably has a tensile elongation of 60% or more at which the base material does not break but the coat layer cracks (which may be referred to as a “coat cracking elongation,” hereinafter) when the protective sheet is stretched at a width of 15 mm, a measurement length of 50 mm, and a tensile speed of 200 mm/min in an environment of 23° C. and 50% RH. The detailed measurement method for the coat cracking elongation in the present specification is as described in the testing example, which will be described later.

The protective sheet according to the present embodiment preferably has an indentation stress of 1 to 8.8 N when the surface of the protective sheet on the coat layer side is indented to a depth of 100 μm at a speed of 0.01 mm/sec over an area of 5 mmφ. Here, the thickness of the protective sheet to be measured is within a range of 110 to 1000 μm. If a single protective sheet is insufficient to achieve this thickness, a plurality of protective sheets will be laminated to fall within the range of thickness. The detailed measurement method for the indentation stress in the present specification is as described in the testing example, which will be described later.

The protective sheet according to the present embodiment particularly has the above coat cracking elongation thereby to exhibit high flexibility and extensibility, and can easily follow curved surfaces and provide excellent workability. Moreover, particularly due to the above indentation stress, even if the coat layer is scratched, the scratch becomes less visible within a short period of time (e.g., 0.1 to 10 minutes), and the surface of the protective sheet according to the present embodiment easily returns to its original state, resulting in excellent scratch recovery.

From the viewpoint of the above workability, the coat cracking elongation is more preferably 65% or more, particularly preferably 70% or more, further preferably 75% or more, and especially preferably 80% or more. While the upper limit of the coat cracking elongation is not particularly limited, it is generally preferred to be 150% or less, more preferably 140% or less, and particularly preferably 130% or less.

From the viewpoint of the above scratch recovery, the above indentation stress is more preferably 3 to 8.7 N, particularly preferably 5 to 8.6 N, further preferably 7 to 8.5 N, and especially preferably 8.1 to 8.4 N.

In the protective sheet according to the present embodiment, the ratio of the indentation amount (μm) when a load of 10 N is applied to the surface of the protective sheet on the coat layer side at a speed of 0.01 mm/min over an area of 5 mm diameter to the thickness (μm) of the protective sheet (%; indentation ratio) is preferably 72% to 99.9%, more preferably 72.5% to 99%, particularly preferably 73% to 90%, further preferably 73.5% to 80%, and especially preferably 74% to 77%. The detailed measurement method for the indentation amount in the present specification is as described in the testing example, which will be described later.

By having the above indentation ratio, the protective sheet according to the present embodiment tends to readily distribute the load applied to the surface on the coat layer side and readily satisfy the above coat cracking elongation. Accordingly, it exhibits high flexibility and extensibility, tends to easily follow curved surfaces, and has excellent workability. Moreover, because the above indentation stress is readily satisfied, the aforementioned scratch recovery is more excellent.

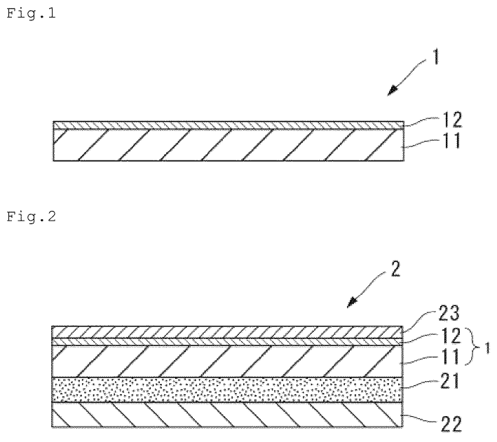

The protective sheet as an example of the present embodiment will now be described with reference to the drawings. As illustrated in FIG. 1, the protective sheet 1 according to the present embodiment includes a base material 11 and a coat layer 12 provided on one surface side of the base material 11. In the protective sheet 1 according to the present embodiment, the coat layer 12 forms the outermost layer.

### 1. Elements

### 1-1. Base Material

The base material 11 has a coat cracking elongation that satisfies the above value, that is, it has a property that it does not break until the coat layer 12 cracks. The breaking elongation of the base material 11 is preferably 100% or more, more preferably 300% or more, particularly preferably 500% or more, and further preferably 600% or more. While the upper limit of the breaking elongation is not limited, it is generally preferred to be 10,000% or less, more preferably 5,000% or less, particularly preferably 2,000% or less, and further preferably 1,000% or less. The breaking elongation is measured by stretching a sample using a tensile tester at a measurement width of 15 mm, a measurement length of 50 mm, and a tensile speed of 200 mm/min in an environment of 23° C. and 50% RH.

Preferred examples of materials constituting the base material 11 include polyurethane, polyvinyl chloride, polyolefin, and other similar materials. Among these, materials containing polyurethane are preferred. In this case, the polyurethane content is preferably 10 mass % or more, more preferably 30 mass % or more, particularly preferably 40 mass % or more, and further preferably 50 mass % or more. The upper limit of the content is preferably 100 mass %, and may be 90 mass % or less.

Examples of polyurethanes for use include polyester-based polyurethanes, polyether-based polyurethanes, and polycarbonate-based polyurethanes. Among these, polyester-based polyurethanes are preferred due to their high extensibility and excellent workability. From the viewpoint of high breaking elongation, polyurethanes are preferably thermoplastic elastomers obtained by polymerizing diisocyanates, low-molecular-weight diols as chain extenders with molecular weights of less than 500, and high-molecular-weight diols with molecular weights of 500 to 4000.

If necessary, the materials constituting the base material 11 may contain additives such as stabilizers, glidants, fillers, colorants, processing aids, softeners, metal powders, anti-fogging agents, UV absorbers, antioxidants, antistatic agents, and flame retardants. Preferred examples of stabilizers for use include Ba—Zn, Cd—Ba, and Sn-based stabilizers. These stabilizers may also be used in combination with epoxidized soybean oil, epoxy resins, and the like. Preferred examples of softeners for use include, for example, ethylene/vinyl acetate copolymer and ethylene/vinyl acetate/carbon monoxide copolymer. From the viewpoint of the SDGs, the material constituting the base material 11 for use may be a highly biomass material, a recyclable or reusable material, or a recycled or reused material.

The thickness of the base material 11 is preferably 10 to 300 μm, more preferably 30 to 260 μm, particularly preferably 50 to 220 μm, further preferably 70 to 200 μm, and especially preferably 90 to 180 μm. This ensures protection for the object to be protected and improves the followability to curved surfaces and, ultimately, the workability.

### 1-2. Coat Layer

The coat layer 12 is preferably formed of a material that satisfies the aforementioned physical properties.

The coat layer 12 preferably contains a fluorine component and/or a silicone component. This results in water- and oil-repellent properties and antifouling property. In particular, the coat layer 12 preferably contains a fluorine-based polymer and a silicone component. This improves water- and oil-repellent properties while maintaining flexibility, resulting in even better antifouling property. From the viewpoint of the SDGs, the material constituting the coat layer 12 for use may be a highly biomass material, a recyclable or reusable material, or a recycled or reused material.

The coat layer 12 is preferably cured with active energy rays. While thermosetting materials require a seasoning period, active energy ray-curable materials do not require this period, and the lead time to the next step can therefore be shortened. Furthermore, if a thermosetting material fails to cure properly, the surface of the coat layer may become micro-rough during the seasoning period, which may be problematic. Fortunately, however, active energy ray-curable materials complete curing immediately after irradiation with active energy rays, thus reducing the risk of problems due to insufficient curing.

When the coat layer 12 contains a silicone component, it is preferred that the silicone component should be cured with active energy rays. This improves the strength of the coat layer 12 formed, making it more difficult for contaminants to penetrate the coat layer 12, and the antifouling property is more excellent. When the coat layer 12 contains a fluoropolymer in addition to the silicone component, it is also preferred that the fluoropolymer should be cured with active energy rays. This improves the flexibility and cohesive strength while improving the antifouling property.

The coat layer 12 is preferably formed by curing with active energy rays a composition that contains an active energy ray-curable fluorine-based resin (A) and an active energy ray-curable silicone compound (B) (this composition may be referred to as a “composition for coat layer C,” hereinafter). This allows the aforementioned physical properties to be readily satisfied, resulting in more excellent workability and scratch recovery, and the antifouling property is more excellent. Furthermore, no seasoning period is required after the coat layer 12 is formed.

### (1) Components

### (1-1) Active Energy Ray-Curable Fluorine-Based Resin (A)

Preferred examples of the active energy ray-curable fluorine-based resin (A) include fluorine-based resins having structural units derived from fluorine-containing monomers and structural units derived from crosslinkable monomers. Specific examples of the fluorine-containing monomer units include fluoroolefins such as fluoroethylene, vinylidene fluoride, tetrafluoroethylene, hexafluoroethylene, hexafluoropropylene, and perfluoro-2,2-dimethyl-1,3-dioxole; fluorinated alkyl ester derivatives of (meth)acrylic acid; and fluorinated vinyl ethers. Examples of the crosslinkable monomers include (meth)acrylate monomers as well as (meth)acrylate monomers having carboxyl groups, hydroxyl groups, amino groups, sulfonic acid groups, etc. As used in the present specification, the term “(meth)acrylic acid” refers to both the acrylic acid and the methacrylic acid. The same applies to other similar terms.

The active energy ray-curable fluorine-based resin (A) is preferably an active energy ray-curable silicon-containing fluorine-containing resin. This allows the aforementioned physical properties to be more readily satisfied, resulting in furthermore excellent workability and scratch recovery, and the antifouling property is furthermore excellent.

The active energy ray-curable silicon-containing fluorine-containing resin is preferably a silsesquioxane compound having an active energy ray-curable functional group and a fluorine atom. Silsesquioxane compounds refer to a general term for polysiloxane compounds whose majority structure is represented by the structural formula [RSiO_{1.5}] (each R independently represents any organic group, and two or more R may be linked together), and examples thereof include ladder-shaped silsesquioxane compounds, cage-shaped silsesquioxane compounds, and indefinite-shaped silsesquioxane compounds. Among these, cage-shaped silsesquioxane compounds are preferred.

Preferred examples of commercially available cage-shaped silsesquioxane compounds having an active energy ray-curable functional group and a fluorine atom include, for example, “Sila-Max (registered trademark) XC0199-40,” “Sila-Max (registered trademark) XC0208-40,” and “Sila-Max (registered trademark) XC0212-40” available from JNC petro chemical Co., Ltd.

Cage-shaped silsesquioxane compounds having an active energy ray-curable functional group and a fluorine atom can be produced, for example, by reacting a cage-shaped silsesquioxane compound having a reactive group and a fluorine atom (preferably a fluoroalkyl group) with a reactive silicone (preferably a reactive polydimethylsiloxane having a reactive functional group at one or both ends of a linear siloxane chain).

The content of the active energy ray-curable fluorine-based resin (A) in the composition for coat layer C is preferably 50 to 99.9 mass %, more preferably 60 to 99 mass %, particularly preferably 70 to 98.5 mass %, further preferably 80 to 98 mass %, and especially preferably 90 to 97.5 mass %. This allows the aforementioned physical properties to be readily satisfied, resulting in more excellent workability and scratch recovery, and the antifouling property is more excellent.

### (1-2) Active Energy Ray-Curable Silicone Compound (B)

Examples of the active energy ray-curable silicone compound (B) include radical addition silicone compounds containing an alkenyl group and a mercapto group in the molecule, hydrosilylation reaction-type silicone compounds containing an alkenyl group and a hydrogen atom in the molecule, cationic polymerization-type silicone compounds containing an epoxy group, and radical polymerization-type silicone compounds containing a (meth)acryloyl group. Among these, radical polymerization-type silicone compounds containing a (meth)acryloyl group are preferred.

Examples of radical polymerization-type silicone compounds include compounds represented by General Formula (1) below.

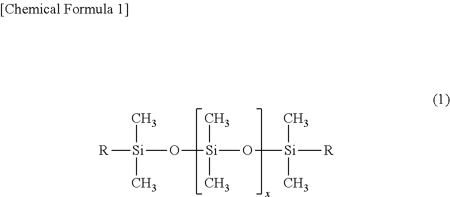

In General Formula (1), R represents a hydrogen atom, a methyl group, a hydrosilyl group, or a methoxy group, and X represents an integer of 0 to 1,200. At least one of the methyl groups in General Formula (1) is substituted with an alkyl group containing a (meth)acryloyl group.

Preferred alkyl groups containing a (meth)acryloyl group are groups represented by —(CH₂)_{y}—O—CO—C(R′)═CH₂ (where y is an integer of 2 to 8, preferably 3 or 4; R′ represents a hydrogen atom or a methyl group). In General Formula (1), methyl groups not substituted with alkyl groups containing a (meth)acryloyl group may be substituted with (poly)ether alkyls, aralkyls, long-chain fatty acid esters, higher fatty acid esters, higher fatty acid amides, or the like.

Preferred examples of radical polymerization-type silicone compounds containing a (meth)acryloyl group include silicone-modified polyurethane (meth)acrylates in which polyorganosiloxane and polyurethane (meth)acrylate are integrated by covalent bond.

Commercially available active energy ray-curable silicone compounds (B) include, for example, “SHIKOH (registered trademark) UV-AF100” available from Mitsubishi Chemical Group Corporation, “UMS-182,” “UMS-992,” “RMS-044,” and “RMS-083” available from CHISSO CORPORATION, “X-22” and “X-24” available from Shin-Etsu Chemical Co., Ltd., and “GS1015” available from TOAGOSEI CO., LTD. One type of the active energy ray-curable silicone compound (B) may be used alone or two or more types may also be used in combination.

The content of the active energy ray-curable silicone compound (B) in the composition for coat layer C is preferably 0.1 to 50 mass parts, more preferably 1 to 35 mass parts, particularly preferably 2 to 20 mass parts, and further preferably 3 to 12 mass parts with respect to 100 mass parts of the active energy ray-curable fluorine-based resin (A). This results in more excellent antifouling property.

### (1-3) Photopolymerization Initiator (D)

When ultraviolet rays are used as the active energy rays for curing the composition for coat layer C, the composition for coat layer C preferably contains a photopolymerization initiator (D). This allows the composition for coat layer C to be efficiently cured, and the polymerization curing time and the irradiation amount of the ultraviolet rays can be reduced.

Examples of the photopolymerization initiator (D) include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminobenzoate, oligo[2-hydroxy-2-methyl-1[4-(1-methylvinyl)phenyl]propane], 2,4,6-trimethylbenzoyl-diphenyl-phosphine oxide, bis(2,4,6-trimethylbenzoyl)-phenylphosphine oxide, and 2-hydroxy-1-{4-[4-(2-hydroxy-2-methyl-propionyl)-benzyl]phenyl}-2-methyl-propan-1-one. These may each be used alone or two or more types may also be used in combination.

The content of the photopolymerization initiator (D) in the composition for coat layer C is preferably 0.01 to 30 mass parts, more preferably 0.05 to 20 mass parts, particularly preferably 0.1 to 10 mass parts, and further preferably 0.5 to 5 mass parts with respect to 100 mass parts of the total of the active energy ray-curable fluorine-based resin (A) and the active energy ray-curable silicone compound (B). This allows the aforementioned physical properties to be readily satisfied, resulting in more excellent workability and scratch recovery

### (1-4) Various Additives

If desired, the composition for coat layer C may contain various commonly used additives, such as light stabilizers, oxygen absorbers, antioxidants, softeners, colorants, ultraviolet absorbers, infrared absorbers, antistatic agents, fillers, and refractive index adjusters. From the viewpoint of omitting the seasoning period, it is preferred for the composition to contain no thermal crosslinker, and more preferably to contain substantially no thermal crosslinker. Even when a thermal crosslinker is contained, its content is preferably 0.01 mass % or less.

### (2) Preparation of Composition for Coat Layer

The composition for coat layer C can be produced through mixing the active energy ray-curable fluorine-based resin (A) and the active energy ray-curable silicone compound (B), and, if desired, adding the photopolymerization initiator (D), other additives, etc. Furthermore, by adding an appropriate dilution solvent, a coating liquid of the composition for coat layer C can be obtained.

Examples of the above dilution solvent for use include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol, butanol and 1-methoxy-2-propanol, ethers such as propylene glycol monomethyl ether, ketones such as acetone, methyl ethyl ketone, 2-pentanone, isophorone and cyclohexanone, esters such as ethyl acetate and butyl acetate, and cellosolve-based solvents such as ethyl cellosolve.

The concentration/viscosity of the coating liquid of the composition for coat layer C prepared in this manner are not particularly limited and can be appropriately selected depending on the situation, provided that the concentration/viscosity fall within any range in which the coating is possible. For example, the composition for coat layer C may be diluted to a concentration of 10 to 60 mass %. When obtaining the coating liquid, the addition of a dilution solvent or the like is not a necessary condition, and the dilution solvent may not be added if the composition for coat layer C has a viscosity or the like that enables the coating.

### (3) Formation of Coat Layer

To form the coat layer 12, it is preferred to apply the coating liquid of the composition for coat layer C to one surface side of the base material 11, heat-dry it as appropriate, and then irradiate the obtained coating film with active energy rays.

Methods used for applying the coating liquid of the composition for coat layer C include bar coating, knife coating, roll coating, blade coating, die coating, and gravure coating methods.

When heat-drying is performed, the heating temperature is preferably 70° C. to 150° C. and particularly preferably 80° C. to 125° C. The heating time is preferably 10 seconds to 10 minutes and particularly preferably 20 seconds to 5 minutes.

The active energy rays refer to electromagnetic wave or charged particle radiation having an energy quantum, and specific examples of the active energy rays include ultraviolet rays and electron rays. Among the active energy rays, ultraviolet rays are particularly preferred because they are easy to handle.

Irradiation with ultraviolet rays can be performed using a high-pressure mercury lamp, a Heraeus H lamp, a xenon lamp, etc., and the amount of irradiation with ultraviolet rays is preferably 30 to 1,000 mW/cm² in terms of illuminance, and more preferably 60 to 600 mW/cm². The light amount is preferably 50 to 10,000 mJ/cm², more preferably 100 to 5,000 mJ/cm², and particularly preferably 150 to 2,000 mJ/cm². On the other hand, irradiation with electron rays can be performed by an electron ray accelerator or the like, and the irradiation amount of the electron rays is preferably about 10 to 1,000 krad.

### (4) Physical Properties

### (4-1) Thickness

The thickness of the coat layer 21 is preferably 1 to 50 μm, more preferably 2 to 30 μm, particularly preferably 3 to 20 μm, further preferably 3.5 to 12 μm, and especially preferably 4 to 8 μm. This allows the aforementioned physical properties to be readily satisfied, resulting in more excellent workability and scratch recovery. Moreover, when a silicone component is contained, the antifouling property is more excellent.

### (4-2) Water Contact Angle

The water contact angle on the surface of the coat layer 21 is preferably 100° or more, more preferably 100.5° to 160°, and particularly preferably 101° to 140°. This results in more excellent antifouling property, particularly against water-based stains. The water contact angle refers to an angle that is formed, in a state in which a water droplet is stationarily placed on the surface of the coat layer, between the tangent of the water droplet at the contact portion of the water droplet with the above coat layer surface and the surface of the above coat layer and that is on the side including the water droplet.

### (4-3) Oleic Acid Contact Angle

The oleic acid contact angle on the surface of the coat layer 21 is preferably 52° or more, more preferably 52.5° to 120°, and particularly preferably 53° to 90°. This results in more excellent antifouling property, particularly against oil-based stains. The oleic acid contact angle refers to an angle that is formed, in a state in which a liquid droplet of oleic acid is stationarily placed on the surface of the coat layer, between the tangent of the liquid droplet at the contact portion of the liquid droplet with the above coat layer surface and the surface of the above coat layer and that is on the side including the liquid droplet.

### 2. Physical Properties of Protective Sheet

### (1) Thickness

The thickness of the protective sheet 1 is preferably 10 to 1000 μm, more preferably 30 to 600 μm, particularly preferably 50 to 300 μm, further preferably 70 to 200 μm, and especially preferably 90 to 180 μm. This ensures protection for the object to be protected and improves the followability to curved surfaces and, ultimately, the workability. Moreover, the scratch recovery is more excellent.

### (2) Haze Value

The haze value of the protective sheet 1 is preferably 10% or less, more preferably 5% or less, particularly preferably 1% or less, further preferably 0.6% or less, and especially preferably 0.4% or less. This prevents damage to the appearance of the object to be protected to which the protective sheet 1 is applied. While the lower limit of the above haze value is not particularly limited, 0% is most preferred, but 0.01% or more is preferred, and 0.1% or more is particularly preferred. The haze value as referred to in the present specification is a value measured in accordance with JIS K7136: 2000, and the specific testing method is as described in the testing example, which will be described later.

### (3) Total Luminous Transmittance

The total luminous transmittance of the protective sheet 1 is preferably 80% or more, more preferably 84% or more, particularly preferably 88% or more, and further preferably 90% or more. This prevents damage to the appearance of the object to be protected to which the protective sheet 1 is applied. While the upper limit of the above total luminous transmittance is not particularly limited, 100% is most preferred, but 99.9% or less is preferred, and 99% or less is particularly preferred. The total luminous transmittance as referred to in the present specification is a value measured in accordance with JIS K7361-1: 1997, and the specific testing method is as described in the testing example, which will be described later.

<Protective Sheet with Pressure Sensitive Adhesive Layer>

The protective sheet with pressure sensitive adhesive layer according to an embodiment of the present invention includes the protective sheet according to the aforementioned embodiment and a pressure sensitive adhesive layer laminated on the surface of the protective sheet on the base material side. The protective sheet with pressure sensitive adhesive layer according to the present embodiment can be attached to the object to be protected via the pressure sensitive adhesive layer, allowing for easy application.

The protective sheet with pressure sensitive adhesive layer, which is an example of the present embodiment, will now be described with reference to the drawings. As illustrated in FIG. 2, a protective sheet with pressure sensitive adhesive layer 2 according to the present embodiment includes a protective sheet 1 including a base material 11 and a coat layer 12, a pressure sensitive adhesive layer 21 laminated on the surface of the protective sheet 1 on the base material 11 side, a release sheet 22 laminated on the pressure sensitive adhesive layer 21 on the side opposite to the protective sheet 1, and a protective film 23 laminated on the side of the coat layer 12 opposite to the base material 11.

The release sheet 22 protects the pressure sensitive adhesive surface of the pressure sensitive adhesive layer 21 until the protective sheet with pressure sensitive adhesive layer 2 is used, and it is released and removed when the protective sheet with pressure sensitive adhesive layer 2 is applied (particularly immediately before application). The protective film 23 protects the coat layer 12 until the protective sheet with pressure sensitive adhesive layer 2 is used, and it is released and removed when the protective sheet with pressure sensitive adhesive layer 2 is applied (particularly immediately before application).

### 1. Elements

### 1-1. Protective Sheet

The protective sheet 1 in the present embodiment is the protective sheet 1 according to the aforementioned embodiment.

### 1-2. Pressure Sensitive Adhesive Layer

The pressure sensitive adhesive layer 21 in the present embodiment is not particularly limited, provided that it allows the protective sheet 1 to be attached to the object to be protected and does not impair the workability. The type of the pressure sensitive adhesive constituting the pressure sensitive adhesive layer 21 may be any of acrylic-based one, polyester-based one, polyurethane-based one, rubber-based one, silicone-based one, etc. The pressure sensitive adhesive may be any of emulsion type, solvent type, and solventless type, and may be any of crosslinked type and non-crosslinked type. It may also be thermosetting (thermally crosslinkable) one or active energy ray-curable one. Among these, acrylic-based pressure sensitive adhesives are preferred because of their excellent pressure sensitive adhesive properties, optical characteristics, etc.

An acrylic-based pressure sensitive adhesive that is preferably used is a (meth)acrylic ester polymer, which contains a (meth)acrylic acid alkyl ester as the primary monomer component and, if necessary, is copolymerized with a monomer that can be copolymerized with the (meth)acrylic acid alkyl ester. The (meth)acrylic ester polymer is preferably crosslinked with a crosslinker. If necessary, it is also preferred to contain additives such as ultraviolet absorbers, infrared absorbers, silane coupling agents, antistatic agents, colorants, and optical adjusters.

From the viewpoint of the SDGs, the material constituting the pressure sensitive adhesive layer 21 for use may be a highly biomass material, a recyclable or reusable material, or a recycled or reused material.

The thickness of the pressure sensitive adhesive layer 21 is preferably 1 to 200 μm, more preferably 5 to 120 μm, particularly preferably 10 to 80 μm, and further preferably 15 to 40 μm. This allows the good adhesive strength, workability, reworkability, etc. to be readily obtained.

### 1-3. Release Sheet

Examples of the release sheet 22 for use include polyethylene film, polypropylene film, polybutene film, polybutadiene film, polymethylpentene film, polyvinyl chloride film, vinyl chloride copolymer film, polyethylene terephthalate film, polyethylene naphthalate film, polybutylene terephthalate film, polyurethane film, ethylene vinyl acetate film, ionomer resin film, ethylene-(meth)acrylic acid copolymer film, ethylene-(meth)acrylic ester polymer film, polystyrene film, polycarbonate film, polyimide film, and fluororesin film. Crosslinked films of these may also be used. Furthermore, laminated films of these may also be used. From the viewpoint of the SDGs, the material constituting the release sheet for use may be a highly biomass material, a recyclable or reusable material, or a recycled or reused material.

The release surface of the release sheet 22 (surface that is in contact with the pressure sensitive adhesive layer 21) is preferably subjected to a release treatment. Examples of release agents used in the release treatment include alkyd-based, silicone-based, fluorine-based, unsaturated polyester-based, polyolefin-based, and wax-based release agents.

The thickness of the release sheet 22 is not particularly limited, but is preferably 10 to 250 μm and more preferably 20 to 150 μm.

### 1-4. Protective Film

The protective film 23 is not particularly limited, provided that it can protect the coat layer 12 of the protective sheet 1. Examples of the protective film 23 for use include those that use a polyester film such as polyethylene terephthalate film or a polyolefin film such as polyethylene film or polypropylene film as a base material, with a pressure sensitive adhesive layer composed of a slightly pressure sensitive adhesive provided on one surface side of the base material. From the viewpoint of the SDGs, the material constituting the protective film 23 for use may be a highly biomass material, a recyclable or reusable material, or a recycled or reused material.

While the thickness of the protective film 23 is not particularly limited, it is preferably 5 to 250 μm and more preferably 10 to 150 μm.

### 2. Production Method

In a production example of the protective sheet with pressure sensitive adhesive layer 2, the protective film 23 is first attached to the surface of the coat layer 12 of the protective sheet 1. On the other hand, the pressure sensitive adhesive layer 21 is formed on the release surface of the release sheet 22, and the exposed surface of the pressure sensitive adhesive layer 21 formed and the surface of the protective sheet 1 on the base material 11 side are attached to each other. Alternatively, the pressure sensitive adhesive layer 21 may be formed on the surface of the protective sheet 1 on the base material 11 side, and the exposed surface of the pressure sensitive adhesive layer 21 formed and the release surface of the release sheet 22 may be attached to each other.

Formation of the pressure sensitive adhesive layer 21 can be performed by an ordinary method, usually by applying the coating liquid of the pressure sensitive adhesive, followed by heat treatment and/or aging as necessary.

Methods used for applying the coating liquid of the pressure sensitive adhesive include bar coating, knife coating, roll coating, blade coating, die coating, and gravure coating methods.

### 3. Use Application

The protective sheet with pressure sensitive adhesive layer 2 according to the present embodiment can easily follow curved surfaces, offers excellent workability, and also exhibits excellent scratch recovery, and it is therefore suitably used for protecting coating films on mobile objects, particularly automobiles and motorcycles. When the protective sheet with pressure sensitive adhesive layer 2 has an antifouling property, it is particularly suitable for use on mobile objects, buildings, etc. used outdoors. In addition to protection of coating films, it can also be used on glass windows of mobile objects, buildings, etc. Moreover, it can also be used to protect coating films, housings, and transparent members of various electronic devices (such as personal computers, smartphones, and tablets) and electrical appliances. Furthermore, it can also be used to protect various optical components, particularly flexible displays, stretchable displays, etc.

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

For example, one or more other layers may be interposed between the base material 11 and the coat layer 12 in the protective sheet 1, and one or more other layers may be interposed between the base material 11 and the pressure sensitive adhesive layer 21 in the protective sheet with pressure sensitive adhesive layer 2. The release sheet 22 may be omitted.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

### EXAMPLES

Hereinafter, the present invention will be described further specifically with reference to examples, etc., but the scope of the present invention is not limited to these examples, etc.

### Example 1

### 1. Preparation of Coating Liquid of Composition for Coat Layer

A coating liquid of the composition for coat layer was prepared by mixing 100 mass parts (solid content equivalent) of an ultraviolet-curable silicon-containing fluororesin (available from JNC petro chemical Co., Ltd., product name “Sila-Max XC0199-40”) as the active energy ray-curable fluorine-based resin (A) with 5.0 mass parts (solid content equivalent) of an ultraviolet-curable silicone compound (available from Mitsubishi Chemical Group Corporation, product name “SHIKOH (registered trademark) UV-AF100”) as the active energy ray-curable silicone compound (B).

### 2. Production of Protective Sheet

The coating liquid of the composition for coat layer prepared above was applied to one surface side of a polyurethane resin film (available from Seikoh Chemicals Co., Ltd., product name “LUCKSKIN F9700ES-150C,” thickness: 150 μm, breaking elongation: 700%) as the base material using a bar coater and dried at 80° C. for 1 minute to form a coating film. The coating film was then irradiated with ultraviolet rays at an illuminance of 80 mW/cm² and a light amount of 200 mJ/cm² in a nitrogen atmosphere to form a 4 μm-thick coat layer, which was provided as a protective sheet (thickness: 154 μm).

### Examples 2 and 3

Coating liquids of the compositions for coat layers were prepared in the same manner as in Example 1 except that the amounts of the active energy ray-curable silicone compounds (B) to be mixed were as listed in Table 1. Then, protective sheets were produced in the same manner as in Example 1 using the coating liquids of the compositions for coat layers.

### Example 4

A coating liquid of the composition for coat layer was prepared by mixing 100 mass parts (solid content equivalent) of an ultraviolet-curable silicon-containing fluororesin (available from JNC petro chemical Co., Ltd., product name “Sila-Max XC0199-40”) as the active energy ray-curable fluorine-based resin (A) with 5.0 mass parts (solid content equivalent) of an ultraviolet-curable silicone compound (available from Mitsubishi Chemical Group Corporation, product name “SHIKOH (registered trademark) UV-AF100”) as the active energy ray-curable silicone compound (B) and 1.0 mass parts (solid content equivalent) of 2-hydroxy-1-{4-[4-(2-hydroxy-2-methyl-propionyl)-benzyl]phenyl}-2-methyl-propan-1-one (D1) as the photopolymerization initiator (D).

A protective sheet was produced in the same manner as in Example 1 using the coating liquid of the composition for coat layer obtained above.

### Example 5

A coating liquid of the composition for coat layer was prepared in the same manner as in Example 4 except that the amount of the photopolymerization initiator (D) to be mixed was as listed in Table 1. Then, a protective sheet was produced in the same manner as in Example 1 using the coating liquid of the composition for coat layer.

### Example 6

A coating liquid of the composition for coat layer was prepared in the same manner as in Example 4 except that the photopolymerization initiator (D) was 2,2-dimethoxy-2-phenylacetophenone (D2) as listed in Table 1. Then, a protective sheet was produced in the same manner as in Example 1 using the coating liquid of the composition for coat layer.

### Comparative Example 1

A coating liquid of the composition for coat layer was prepared using only an ultraviolet-curable silicon-containing fluororesin (available from JNC petro chemical Co., Ltd., product name “Sila-Max XC0199-40”) as the active energy ray-curable fluorine-based resin (A) (dissolved in a mixed solvent of propylene glycol monomethyl ether and methyl ethyl ketone (solid concentration: 40 mass %)), and a protective sheet was produced in the same manner as in Example 1.

### Comparative Example 2

A coating liquid of the composition for coat layer was prepared by mixing 100 mass parts (solid content equivalent) of an ultraviolet-curable silicon-containing fluororesin (available from JNC petro chemical Co., Ltd., product name “Sila-Max XC0199-40”) as the active energy ray-curable fluorine-based resin (A) with 5.0 mass parts (solid content equivalent) of a polyether-modified silicone (available from Dow Toray Co., Ltd., product name “DOWSIL SH28 PAINT ADDITIVE”) as a surface modifier.

A protective sheet was produced in the same manner as in Example 1 using the coating liquid of the composition for coat layer obtained above.

### Comparative Example 3

A coating liquid of the composition for coat layer was prepared by mixing 100 mass parts (solid content equivalent) of a polyfunctional acrylate (available from SARTOMER COMPANY, product name “SR399E”) with 5.0 mass parts (solid content equivalent) of an ultraviolet-curable silicone compound (available from Mitsubishi Chemical Group Corporation, product name “SHIKOH UV-AF100”) as the active energy ray-curable silicone compound (B) and 1.0 mass parts (solid content equivalent) of 2,2-dimethoxy-2-phenylacetophenone (D2) as the photopolymerization initiator (D).

A protective sheet was produced in the same manner as in Example 1 using the coating liquid of the composition for coat layer obtained above.

### <Testing Example 1> (Measurement of Coat Cracking Elongation)

The protective sheet produced in each of Examples and Comparative Examples was cut into 15 mm×100 mm, and this was used as a sample. This sample was placed in a precision universal tester (available from Shimadzu Corporation, product name “AG-IS”) with a jig distance (measurement length) of 50 mm, and a tensile test was performed in accordance with JIS K7127: 1999 at 23° C. and a relative humidity of 50% RH at a tensile speed of 200 mm/min. Then, the tensile elongation (%) at which the coat layer cracked without breaking the base material was measured as the coat cracking elongation (%). The results are listed in Table 2.

The tensile elongation is calculated using the following formula.

$$Tensile elongation ( \% ) = ( Stretched distance / Jig distance ( measurement length ) ) \times 100$$

### <Testing Example 2> (Measurement of Indentation Stress)

A pressure sensitive adhesive layer for optical use (available from LINTEC Corporation, product name “OPTERIA MO-3014,” pressure sensitive adhesive thickness: 25 μm, total luminous transmittance: >90%, haze value: <1.0%) was bonded to the surface on the base material side of the protective sheet produced in each of Examples and Comparative Examples. The protective sheet was attached to a soda-lime glass plate (available from Nippon Sheet Glass Co., Ltd., 0.7 mm) via the pressure sensitive adhesive layer to produce a laminate having a configuration of coat layer/base material/pressure sensitive adhesive layer/glass plate.

Under a temperature of 23° C. and a relative humidity of 50% RH, a texture analyzer (available from Stable Micro Systems, product name “TA.XT.Plus”) was used to press a probe (product number: P/5S, tip shape: spherical, size: 5 mm diameter, material: stainless steel) against the surface of the coat layer of the above laminate, and the stress (N) when the probe was indented to a depth of 100 μm at an indentation speed of 0.01 mm/sec was measured, which was adopted as the indentation stress (N). The results are listed in Table 2.

### <Testing Example 3> (Measurement of Indentation Amount)

A laminate was prepared in the same manner as in Testing Example 2. Under a temperature of 23° C. and a relative humidity of 50% RH, a texture analyzer (available from Stable Micro Systems, product name “TA.XT.Plus”) was used to press a probe (product number: P/5S, tip shape: spherical, size: 5 mm diameter, material: stainless steel) against the surface of the coat layer of the above laminate, and a load was continuously applied at an indentation speed of 0.01 mm/sec. Once the load reached 10 N and was held for 5 seconds, the indentation depth (μm) was measured, which was adopted as the indentation amount (μm).

Then, the ratio (%) of the measured indentation amount (μm) to the thickness (μm) of the protective sheet (%; indentation ratio) was calculated. The results are listed in Table 2.

### <Testing Example 4> (Measurement of Haze Value)

The haze values (%) of the protective sheet produced in each of Examples and Comparative Examples was measured using a haze meter (available from NIPPON DENSHOKU INDUSTRIES CO., LTD., product name “NDH7000”) in accordance with JIS K7136: 2000. The results are listed in Table 2.

### <Testing Example 5> (Measurement of Total Luminous Transmittance)

The total luminous transmittance (%) of the protective sheet produced in each of Examples and Comparative Examples was measured using a haze meter (available from NIPPON DENSHOKU INDUSTRIES CO., LTD., product name “NDH7000”) in accordance with JIS K7361-1: 1997. The results are listed in Table 2.

### <Testing Example 6> (Measurement of Water Contact Angle)

The water contact angle on the surface of the coat layer of the protect sheet produced in each of Examples and Comparative Examples was measured under the following conditions using a fully automated contact angle meter (available from Kyowa Interface Science Co., Ltd., DM-701). The results are listed in Table 2.
Droplet volume of purified water: 2 μl
Measurement time: 3 seconds after dropping
Image analysis method: θ/2 method

### <Testing Example 7> (Measurement of Oleic Acid Contact Angle)

The oleic acid contact angle on the surface of the coat layer of the protect sheet produced in each of Examples and Comparative Examples was measured under the following conditions using a fully automated contact angle meter (available from Kyowa Interface Science Co., Ltd., DM-701). The oleic acid used was that available from Tokyo Chemical Industry Co., Ltd. The results are listed in Table 2.
Droplet volume of oleic acid: 2 μl
Measurement time: 3 seconds after dropping
Image analysis method: θ/2 method

### <Testing Example 8> (Evaluation of Workability)

A (meth)acrylic ester polymer was prepared by copolymerizing 95 mass parts of n-butyl acrylate and 5 mass parts of acrylic acid using a solution polymerization method. The molecular weight of this (meth)acrylic acid ester polymer was measured using the method described later, and found to have a weight-average molecular weight (Mw) of 500,000. A coating solution of the pressure sensitive adhesive composition was obtained through mixing 100 mass parts of the obtained (meth)acrylic acid ester polymer (solid content) with 0.01 mass parts of an epoxy-based crosslinker (available from MITSUBISHI GAS CHEMICAL COMPANY, INC., product name “TETRAD-X”), sufficiently stirring them, and diluting the mixture toluene.

The coating solution of the pressure sensitive adhesive composition obtained in the above process was applied using a knife coater to the release-treated surface of a release sheet (thickness: 38 μm) obtained by release-treating one surface of a polyethylene terephthalate film with a silicone-based release agent. The coating layer was then subjected to heating treatment at 90° C. for 1 minute to form a pressure sensitive adhesive layer (thickness: 20 μm). The pressure sensitive adhesive layer on the above release sheet was laminated on the base material side of the protective sheet produced in each of Examples and Comparative Examples to produce a laminate having a configuration of coat layer/base material/pressure sensitive adhesive layer/release sheet, which was used as a sample.

The release sheet was removed from the sample, and the exposed surface of the pressure sensitive adhesive layer was manually applied using a squeegee to the driver's side door surface of each of commercially available Automobile 1 (Honda Motor Co., Ltd., Fit) and Automobile 2 (Toyota Motor Co., Ltd., Aqua), and the protective sheet was thus applied.

The workability was then evaluated according to the following criteria. The results are listed in Table 2. Protective sheets whose evaluation result was O were successfully applied to the surface of the entire automobile body in both Automobile 1 and Automobile 2.
◯ . . . In both Automobile 1 and Automobile 2, the protective sheet was able to be attached to the curved surfaces present on the doors with good followability, and was successfully applied without any problems such as wrinkles on the protective sheet.
x . . . In either Automobile 1 or Automobile 2 or both Automobile 1 and Automobile 2, the protective sheet was difficult to follow the curved surfaces present on the doors, resulting in problems such as wrinkles on the protective sheet, making it unsuitable for practical use.

The above-described weight-average molecular weight (Mw) refers to a weight-average molecular weight that is measured as a polystyrene equivalent value under the following conditions using gel permeation chromatography (GPC) (GPC measurement).

### <<Measurement Conditions>>

Measurement device: HLC-8320 available from Tosoh Corporation
GPC columns (passing through in the following order): available from Tosoh Corporation
   TSK Gel Super H-H
   TSK Gel Super HM-H
   TSK Gel Super H2000
Solvent for measurement: tetrahydrofuran
Measurement temperature: 40° C.

### <Testing Example 9> (Evaluation of Scratch Recovery)

The coat layer surface of the protective sheet produced in each of Examples and Comparative Examples was rubbed back and forth 20 times with a brass brush. After that, the scratches were visually checked to determine whether or not they disappeared over time. Scratch recovery was then evaluated according to the following criteria. The results are listed in Table 2.
◯ . . . Scratches disappeared within a few minutes.
x . . . Scratches remained.

### <Testing Example 10> (Evaluation of Antifouling Property)

### (1) Oil-Based Pen

Writing was performed on the coat layer surface of the protective sheet produced in each of Examples and Comparative Examples using an oil-based pen (available from ZEBRA CO., LTD., product name “Mckee Black”). After that, the coat layer surface of the protective sheet was wiped dry with a nonwoven wiper (available from Asahi Kasei Corporation, product name “Bemcot S-2”), and whether or not the writing marks with oil-based pen were wiped away was visually determined. The antifouling property (oil-based pen) was then evaluated according to the following criteria. The results are listed in Table 2.
◯ . . . Writing marks were able to be easily wiped away.
Δ . . . Writing marks were able to be wiped away to some extent, but they were still visible.
x . . . Writing marks were not able to be wiped away.

### (2) Carbon Black

A carbon black aqueous dispersion (carbon black content: 5 mass %) was dropped (amount: 0.5 mL) onto the coat layer surface of the protective sheet produced in each of Examples and Comparative Examples and then dried. After that, the coat layer surface of the protective sheet was washed with running water, and whether or not the carbon black traces were able to be removed was visually determined. The antifouling property (carbon black) was then evaluated according to the following criteria. The results are listed in Table 2.
◯ . . . Carbon black traces were able to be easily removed.
Δ . . . Carbon black traces were able to be removed to some extent, but they were still visible.
x . . . Carbon black traces were not able to be removed.

### <Testing Example 11> (Evaluation of Seasoning)

When producing the protective sheet in each of Examples and Comparative Examples, pencil hardness was measured on the coat layer surface of the protective sheet immediately (day 0) and 30 days after UV irradiation to form the coat layer. Pencil hardness was measured in accordance with JIS K5600 using an electric pencil scratch hardness tester (available from YASUDA SEIKI SEISAKUSHO, LTD., product name “No. 553-M1”). Seasoning was evaluated based on the following criteria. The results are listed in Table 2.
T . . . Pencil hardness was the same immediately after coating (day 0) and 30 days later (=no seasoning required).
N . . . Pencil hardness was higher 30 days after coating than immediately after coating (day 0) (=seasoning required)

TABLE 1

| | Active energy | | Active energy | | | |
|---|---|---|---|---|---|---|
| | ray-curable | | ray-curable | | | |
| | fluorine-based | Polyfunctional | silicone | | | Surface |
| | resin (A) | acrylate | compound (B) | Photopolymerization initiator (D) | | modifier |
| | mass parts | mass parts | mass parts | Type | mass parts | mass parts |
| Example 1 | 100 | — | 5.0 | — | — | — |
| Example 2 | 100 | — | 3.0 | — | — | — |
| Example 3 | 100 | — | 10.0 | — | — | — |
| Example 4 | 100 | — | 5.0 | D1 | 1.0 | — |
| Example 5 | 100 | — | 5.0 | D1 | 3.0 | — |
| Example 6 | 100 | — | 5.0 | D2 | 1.0 | — |
| Comparative Example 1 | 100 | — | — | — | — | — |
| Comparative Example 2 | 100 | — | — | — | — | 5.0 |
| Comparative Example 3 | — | 100 | 5.0 | D2 | 1.0 | — |

TABLE 2

| | | | | | | Total luminous | |
|---|---|---|---|---|---|---|---|
| | Coat cracking | Indentation | Indentation | Indentation | Haze value | transmittance | Contact angle (°) |
| | elongation (%) | stress (N) | amount (μm) | ratio (%) | (%) | (%) | Water |
| Example 1 | 93 | 0.3 | 117 | 78.0 | 0.3 | 90 | 102 |
| Example 2 | 95 | 8.2 | 117 | 78.0 | 0.4 | 90 | 102 |
| Example 3 | 91 | 8.4 | 115 | 74.7 | 0.3 | 90 | 104 |
| Example 4 | 94 | 8.3 | 115 | 74.7 | 0.3 | 90 | 102 |
| Example 5 | 93 | 8.3 | 114 | 74.0 | 0.4 | 90 | 101 |
| Example 6 | 94 | 8.4 | 115 | 74.7 | 0.4 | 90 | 102 |
| Comparative Example 1 | 95 | 8.0 | 121 | 78.6 | 0.3 | 90 | 90 |
| Comparative Example 2 | 96 | 7.9 | 122 | 79.2 | 0.3 | 90 | 99 |
| Comparative Example 3 | <10 | 9.1 | 108 | 70.1 | 0.4 | 90 | 104 |

| | Contact angle (°) | | Scratch | Antifouling property | | Evaluation of |
|---|---|---|---|---|---|---|
| | Oleic acid | Workability | recovery | Oil-based pen | Carbon black | seasoning |
| Example 1 | 54 | ◯ | ◯ | ◯ | ◯ | T |
| Example 2 | 53 | ◯ | ◯ | ◯ | ◯ | T |
| Example 3 | 55 | ◯ | ◯ | ◯ | ◯ | T |
| Example 4 | 54 | ◯ | ◯ | ◯ | ◯ | T |
| Example 5 | 54 | ◯ | ◯ | ◯ | ◯ | T |
| Example 6 | 54 | ◯ | ◯ | ◯ | ◯ | T |
| Comparative Example 1 | 50 | ◯ | ◯ | Δ | X | T |
| Comparative Example 2 | 51 | ◯ | ◯ | Δ | X | T |
| Comparative Example 3 | 53 | X | • | ◯ | Δ | T |

As apparent from Table 2, the protective sheets produced in the examples exhibited excellent workability, scratch recovery, and antifouling property, and did not require seasoning.

### INDUSTRIAL APPLICABILITY

The protective sheet according to the present invention is suitable, for example, as a protective sheet for protecting coating films on automobiles, etc.

### DESCRIPTION OF REFERENCE NUMERALS

1 . . . Protective sheet
   11 . . . Base material
   12 . . . Coat layer
2 . . . Protective sheet with pressure sensitive adhesive layer
   21 . . . Pressure sensitive adhesive layer
   22 . . . Release sheet
   23 . . . Protective film

1. A protective sheet comprising a base material and a coat layer,
the protective sheet having a tensile elongation of 60% or more at which the base material does not break but the coat layer cracks when the protective sheet is stretched at a width of 15 mm, a measurement length of 50 mm, and a tensile speed of 200 mm/min in an environment of 23° C. and 50% RH,
the protective sheet having an indentation stress of 1 N or more and 8.8 N or less when a surface of the protective sheet or a laminate including the protective sheet on the coat layer side is indented to a depth of 100 μm at a speed of 0.01 mm/sec over an area of 5 mmφ.

2. The protective sheet according to claim 1, wherein a ratio of an indentation amount (μm) when a load of 10 N is applied to the surface of the protective sheet on the coat layer side at a speed of 0.01 mm/min over an area of 5 mm diameter to a thickness (μm) of the protective sheet is 72% or more and 99.9% or less.

3. The protective sheet according to claim 1, wherein the coat layer contains a silicone component.

4. The protective sheet according to claim 1, wherein the coat layer contains a fluorine-based polymer and a silicone component.

5. The protective sheet according to claim 3, wherein the silicone component is cured by active energy rays.

6. The protective sheet according to claim 1, wherein the coat layer is cured by active energy rays.

7. The protective sheet according to claim 1, wherein the surface of the protective sheet on the coat layer side has a water contact angle of 1000 or more.

8. The protective sheet according to claim 1, wherein the surface of the protective sheet on the coat layer side has an oleic acid contact angle of 52° or more.

9. The protective sheet according to claim 1, wherein the base material is composed of a material containing 10 mass % or more of polyurethane.

10. The protective sheet according to claim 1, wherein the base material has a thickness of 10 μm or more and 300 μm or less.

11. The protective sheet according to claim 1, wherein the coat layer has a thickness of 1 μm or more and 50 μm or less.

12. A protective sheet with pressure sensitive adhesive layer, comprising:
the protective sheet according to claim 1; and
a pressure sensitive adhesive layer laminated on a surface of the protective sheet on the base material side.
